(19) United States
(12) Patent Application Publication
(10) Pub. No.: US 2026/0076337 A1
(43) Pub. Date: Mar. 19, 2026

(54) ENCLOSURE ASSEMBLY, SYSTEM OF MULTIPLE ENCLOSURE ASSEMBLIES, AND METHOD OF ASSEMBLY THEREOF

(71) Applicant: Mid-West Metal Products Company, Inc., Muncie, IN (US)

(72) Inventors: Stew Kerr, Muncie, IN (US); Michael Eric Greene, Muncie, IN (US); Scott Alan Henry, Albany, IN (US); David J. Nolley, Muncie, IN (US)

(21) Appl. No.: 19/328,698

(22) Filed: Sep. 15, 2025

Related U.S. Application Data
(60) Provisional application No. 63/695,028, filed on Sep. 16, 2024.

(51) Int. Cl. A01K 1/03

(52) U.S. Cl. CPC A01K 1/03

(57) ABSTRACT

An animal enclosure is coupled to a second animal enclosure. The animal enclosure includes a first member, a second member, a third member, and a fourth member. The first member, second member, third member, and fourth member are at least partially formed by a plurality of interconnected horizontal and vertical wires. A support frame is coupled to at least two member of the plurality of members. The first member includes a first plurality of wires and a second plurality of wires, the first plurality of wires extending in a first direction and the second plurality of wires extending in a second direction. The first member has at least on U-shaped wire coupled to at least one of the second plurality of wires.

### RELATED APPLICATIONS

This application claims the benefit of U.S. Provisional Patent Application Ser. No. 63/695,028, filed Sep. 16, 2024, the disclosure of which is hereby incorporated by reference in its entirety.

### FIELD OF THE DISCLOSURE

The present disclosure relates to an enclosure assembly, and in particular to a enclosure assembly for coupling to another enclosure assembly for housing an animal.

### BACKGROUND

The use of animal cages is well known in the prior art. Many conventional cages have been developed over the years for housing animals of different sizes, and through the development of these cages flexibility and portability have become points of emphasis. Some conventional cages, for example, have been designed to collapse to a compact position for portability. Others have been designed of light weight and from durable materials. Conventional cages have been designed for ease of transporting an animal.

Most conventional cages include at least one door for providing access to the interior of the cage. An animal can enter or exit the cage through the opening when the door is opened, and the animal can be safely contained in the cage when the door is closed. Many conventional cages include a door that is attached to the cage via a hinge. This allows the door to be swung open and closed. A spring activated latch or the like have been incorporated into the design of the door to allow a user to open or lock the door.

Many of these conventional designs have limitations, however. For instance, the door that is hingedly attached to the cage can be swung open or closed too quickly and scratch or damage another object such as a wall or furniture. In addition, due to the hinged connection, the door cannot be partially opened, i.e., the door is either open or closed.

Other conventional cages have a limited volume. For example, a large conventional cage is ideally suited for a larger animal, whereas a smaller cage is ideally suited for a smaller animal. However, many conventional cages with a larger capacity may not be suitable for a smaller animal. Further, it is not possible to change or reduce the size of a larger cage to meet the needs of a smaller animal. In some instances, it may be desirable to couple multiple cages or enclosures to one another to form a larger enclosure.

Thus, there is a need for a method and system for coupling two or more animal enclosures to one another to form a larger enclosure.

### SUMMARY

In a first implementation of the present disclosure, an animal enclosure configured to being coupled to a second animal enclosure includes a plurality of members defining an interior of the enclosure, the plurality of members including at least a first member, a second member, a third member, and a fourth member, where the first member, second member, third member, and fourth member are at least partially formed by a plurality of interconnected horizontal and vertical wires; and a support frame coupled to at least two member of the plurality of members; wherein, the first member includes a first plurality of wires and a second plurality of wires, the first plurality of wires extending in a first direction and the second plurality of wires extending in a second direction; wherein, the first member includes at least on U-shaped wire coupled to at least one of the second plurality of wires; wherein, the second member includes a first frame member, a second frame member, a third plurality of wires and a fourth plurality of wires, where the third plurality of wires are disposed generally parallel to the first and second frame members, and at least one of the fourth plurality of wires are coupled to the first and second frame members.

In one example of this implementation, the first and second frame members are formed of rectangular or square cross-sectional tubular members. In a second example, the first member forms a top member of the animal enclosure and the second member forms a bottom member thereof. In a third example, the second member includes a first tab coupled to the first frame member and a second tab coupled to the second frame member, the first tab extending outwardly from the first frame member in one direction and the second tab extending outwardly from the second frame member in another direction. In a fourth example, the first tab and second tab extend in a direction parallel to the fourth plurality of wires.

In a fifth example, the first frame member includes a first end and a second end; the first frame member forms a first opening and a second opening at locations between the first end and the second end, the first opening spaced from the second opening. In a sixth example, the second frame member includes a first end and a second end; wherein, the second frame member forms a third opening and a fourth opening at locations between the first end and the second end of the second frame member, the third opening spaced from the fourth opening. In a seventh example, the first opening is axially aligned with the third opening, and the second opening is axially aligned with the fourth opening.

In an eighth example, the second member includes an intermediate member coupled to the first frame member and the second frame member, the intermediate member located at one end between the first and second openings and at an opposite end thereof between the third and fourth openings. In a ninth example, the support frame includes a top end and a bottom end, the support frame forming a peg at the bottom end and an opening at the top end.

In a tenth example, the first member forms a top, the second member forms a bottom, the third member forms a front, and the fourth member forms a rear, the first member, second member, third member, and fourth member coupled to one another to define the interior of the enclosure. In a further example, the interior of the enclosure is open at a first side and a second side thereof, the first member, second member, third member, and fourth member defining the first side and the second side.

In another example, the second plurality of wires of the first member form an elongate portion, a first bent portion and a second bent portion. In yet another example, the first bent portion is coupled to a first bottom wire and the second bent portion is coupled to a second bottom wire. In a further example, the elongate portion of each of the second plurality of wires is disposed within a first plane and the first and second bottom wires are disposed within a second plane, the first plane being parallel to and offset from the second plane. In yet a further example, the at least one U-shaped wire is coupled in at least two locations along the U-shaped wire to a first wire of the second plurality of wires and to a second wire of the second plurality of wires.

In another implementation of the present disclosure, an animal enclosure assembly is configured to contain an animal. The animal enclosure assembly includes a first enclosure defining a first interior and a second enclosure defining a second interior, the first enclosure and second enclosure being coupled to one another such that the first interior is directly connected to the second interior; the first enclosure including a first plurality of members defining the first interior and the second enclosure comprising a second plurality of members defining the second interior; the first enclosure further including the plurality of members including at least a first member, a second member, a third member, and a fourth member, where the first member, second member, third member, and fourth member are at least partially formed by a plurality of interconnected horizontal and vertical wires; and a support frame coupled to at least two member of the plurality of members; wherein, the first member includes a first plurality of wires and a second plurality of wires, the first plurality of wires extending in a first direction and the second plurality of wires extending in a second direction; wherein, the first member includes at least on U-shaped wire coupled to at least one of the second plurality of wires; wherein, the second member includes a first frame member, a second frame member, a third plurality of wires and a fourth plurality of wires, where the third plurality of wires are disposed generally parallel to the first and second frame members, and at least one of the fourth plurality of wires are coupled to the first and second frame members.

In one example of this implementation, the first frame member includes a first end and a second end; wherein, the first frame member forms a first opening and a second opening at locations between the first end and the second end, the first opening spaced from the second opening; wherein, when the first enclosure and second enclosure are coupled to one another, a first wire of the second enclosure is located within the first opening and a second wire of the second enclosure is located within the second opening. In a second example, the second frame member includes a first end and a second end; wherein, the second frame member forms a third opening and a fourth opening at locations between the first end and the second end of the second frame member, the third opening spaced from the fourth opening; wherein the first wire of the second enclosure is located within the third opening and the second wire of the second enclosure is located within the fourth opening. In another example, the first member forms a top member of the first enclosure and the second member forms a bottom member thereof.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is one implementation of a perspective view of a multi-level animal enclosure assembly;

FIG. 2 is another implementation of a perspective view of a multi-level animal enclosure assembly;

FIG. 3 is one implementation of a perspective view of an enclosure assembly;

FIG. 4 is one implementation of a top member of the enclosure assembly of FIG. 3;

FIG. 5 is one implementation of a bottom member of the enclosure assembly of FIG. 3;

FIG. 6 is a partial perspective view of the bottom member of FIG. 5 being coupled to another enclosure assembly;

FIG. 7 is an exploded perspective view of the bottom member of FIG. 5 and another enclosure assembly of FIG. 6; and

FIG. 8 is a partial perspective view of the top member of FIG. 4 being coupled to another enclosure assembly.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

The present disclosure relates to an enclosure assembly. The enclosure assembly may be a single enclosure assembly or a plurality of enclosure assemblies. In one implementation, the enclosure assembly is formed of wire of a one or more diameters. In other implementations, the enclosure assembly is formed by a plurality of interconnected horizontal and vertical wires. In some implementations, the plurality of enclosure assemblies may include a plurality of wire enclosures each formed by interconnected horizontal and vertical wires. In other implementations, the enclosure assembly may be formed by interconnected wires, but the interconnected wires may or may not be horizontally and/or vertically oriented. In yet other implementations, the enclosure assembly may include some portions of interconnected wires and other portions formed of aluminium, plastic, steel, or other known material.

The enclosure assembly or plurality of enclosure assemblies can be used for multiple purposes, one of which is to contain animals. The enclosure assembly or plurality of enclosure assemblies can be made of any size for accommodating an object of any size. In some implementations, the enclosure assembly may be formed for coupling to another enclosure assembly for increasing an internal volume capable of housing a larger object (e.g., an animal) or a plurality of objects (e.g., multiple animals). In several implementations where there are a plurality of enclosure assemblies, each enclosure assembly may be the same size and shape. In yet other implementations where there are a plurality of enclosure assemblies, at least one enclosure assembly may be a different size and/or shape than another enclosure assembly.

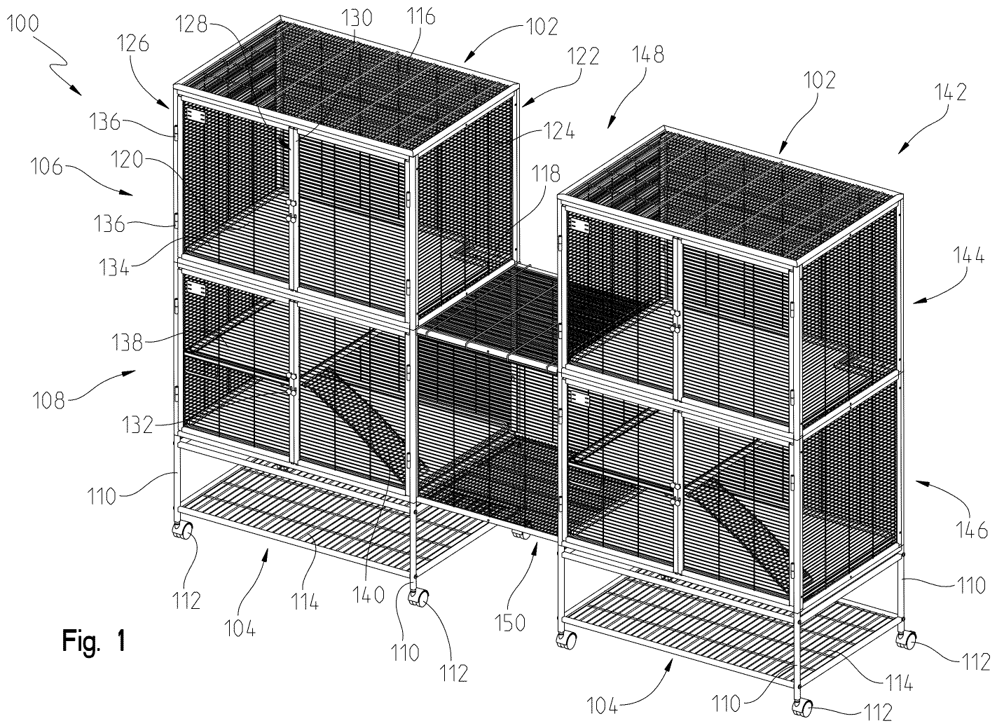

Referring to FIG. 1, one implementation of an animal enclosure in the form of a multi-enclosure assembly 100 of the present disclosure is shown. In this implementation, the multi-enclosure assembly 100 may be formed substantially of interconnected wires and is shown including at least a first enclosure 106 and a second enclosure 108. The multi-enclosure assembly 100 may include a top 102 and a bottom 104 where at the top 102 may be the first enclosure 106 and towards the bottom 104 is the second enclosure 108. In the illustrated implementation, the first enclosure 106 may be located directly above the second enclosure 108. In another implementation, the first enclosure 106 may be located above the second enclosure 108, but not directly above. In a further implementation, the first enclosure may be above and offset from the second enclosure. In yet another implementation, the first enclosure 106 may be located adjacent to the second enclosure 108. In yet a further implementation, the first enclosure 106 may be partially above the second enclosure 108. Other arrangements or configurations of the first and second enclosures may be possible in different implementations, but are contemplated in this disclosure.

In some implementations, the first and second enclosures may be further supported by a plurality of support legs 110. In FIG. 1, a plurality of support legs 110 comprise a first end and a second end. The first end of each support leg 110 may be coupled to either the first or second enclosure, whereas the second end may be coupled to a wheel or caster 112. In this implementation, the multi-enclosure assembly 100 is transportable as the casters 112 roll along a surface such as a ground or floor. One or more of the casters 112 may be configured in a locked state or unlocked state. In an unlocked state, the caster 112 may be free to roll or rotate about a rotational axis. In a locked state, the caster 112 may be held or prevented from rolling or rotating.

In one implementation, a shelf 114 may be coupled to the plurality of support legs 110. In the arrangement shown in FIG. 1, the shelf 114 may be located below the second enclosure 108 but above the casters 112. In some implementations, the shelf 114 may be located closer to the casters to enable larger items to be stored on the shelf 114 compared to if the shelf 114 were closer to the second enclosure 108. The shelf 114 may be formed of wire. In one implementation, the wire may be arranged as a plurality of interconnected wires. The shelf 114 may be sized such that it is approximately the same width and depth as the first and second enclosures. In other implementations, the shelf 114 may be smaller than the first and second enclosures. In other implementations, the shelf 114 may comprise multiple shelves. In other implementations, another shelf 114 may be located between the first and second enclosures.

Referring to FIG. 1, the first enclosure 106 may include a top member 116, a bottom member 118, a front member 120, a back member 122, a first side member 124 and a second side member 126. The first and second side members may be oppositely disposed from one another. In this implementation, the front member 120 can include a door assembly. In other implementations, the first side member 124, second side member 126, or back member 122 may also include a door assembly. Each of the members may be formed by a plurality of interconnecting wires.

Although not shown, the top member 116 and bottom member 118 may include one or more pegs or pins protruding therefrom. The one or more pegs or pins may project downward from a bottom surface of the top member 116 such that each of the one or more pegs or pins may be located within an opening formed in the first side member 124, second side member 126, front member 120 and/or back member 122. As the pegs or pins are inserted into the corresponding openings, the top member 116 may be coupled to the corresponding member. In the same way, the bottom member 118 may include one or more pegs or pins protruding from a top surface thereof. Each of the one or more pegs or pins on the bottom member 118 may be inserted into a corresponding opening formed in the first side member 124, second side member 126, front member 120 and/or back member 122. As such, the bottom member 118 may be coupled to the corresponding first side member 124, second side member 126, front member 120 and/or back member 122 upon the connection of the peg or pin within the opening.

In one implementation, the first side member 124, second side member 126, front member 120 and/or back member 122 may include an opening formed at each corner thereof. In the same way, the top member 116 and bottom member 118 may include a peg or pin protruding therefrom at each corner thereof. The insertion of each peg or pin in the corresponding openings enables the first enclosure 106 to be assembled.

In other implementations, one or more latches may be used for coupling the different members to one another. For example, the front member 120 may be coupled to the first side member 124 and second side member 126 via one or more latches.

In one implementation, the door assembly may include a first door 128 and a second door 130. Each door may be pivotally coupled to the front member 120 via one or more hinges 136. Each of the first door 128 and second door 130 may be opened independently of the other. Each door may include its own latch or locking mechanism 132 for maintaining the door in its closed position.

In some implementations, a pan 134 may be positioned inside the first enclosure 106 and rest against the bottom member 118. The pan 134 may be approximately the same size as the bottom member 118, although in some implementations the pan 134 may differ in size from the bottom member 118.

In other implementations, a shelf 138 may be located in the first enclosure 106 and/or the second enclosure 108. In FIG. 1, a shelf 138 is shown located in the second enclosure 108. The shelf 138 may be formed of a plurality of interconnecting wires similar to the other members of the second enclosure 106. A corresponding pan may be placed on top of the shelf 138 or coupled thereto.

In one implementation, a ramp 140 may be disposed between the shelf 138 and the bottom member 118 or pan 134. The ramp 140 may be configured as a step or plurality of steps formed of wire as shown in FIG. 1, or it may be configured as a generally flat body. The ramp 140 may be coupled to the shelf 138. For example, the ramp 140 may be formed including a pair of elongate wires that extend the length of the ramp. Each end of the pair of elongate wires may include a hooked end of the respective wire for engaging a corresponding wire or surface of the shelf 138.

In some implementations, the first enclosure 106 and/or second enclosure 108 may include one or more shelves 138. There may be a ramp 140 for each shelf 138. In some instances, a ramp 140 may be coupled between shelves 138 to allow an animal to move between shelves 138.

In the implementation of FIG. 1, the second enclosure 108 may be arranged similar to the first enclosure 106. In other words, the second enclosure 108 may include a top member 116, a bottom member 118, a front member 120, a back member 122, a first side member 124 and a second side member 126. The second enclosure 108 may include a door assembly formed in one of the members, and the door assembly may include a first door 128 and a second door 130. Moreover, in some implementations, the second enclosure 108 may include a pan 134, one or more shelves 138, and one or more ramps 140. In at least one implementation, an opening may be formed between the first and second enclosure to provide access therebetween. In this manner, the pan 134 in the first enclosure 106 may include a cut-out to allow an animal to travel therebetween along a ramp (not shown).

As also shown in FIG. 1, a second multi-enclosure assembly 142 may be provided. The second multi-enclosure assembly 142 may be similarly structured as the first multi-enclosure assembly 100. For example, the second multi-enclosure assembly 142 may include a third enclosure 144 and a fourth enclosure 146. The second multi-enclosure assembly 142 may include a top 102 and a bottom 104 where at the top 102 may be the third enclosure 144 and towards the bottom 104 is the fourth enclosure 146. In the illustrated implementation, the third enclosure 144 may be located directly above the fourth enclosure 146. In another implementation, the third enclosure 144 may be located above the fourth enclosure 146, but not directly above. In a further implementation, the third enclosure 144 may be above and offset from the fourth enclosure 146. In yet another implementation, the third enclosure 144 may be located adjacent to the fourth enclosure 146. In yet a further implementation, the third enclosure 144 may be partially above the fourth enclosure 146. Other arrangements or configurations of the third and fourth enclosures may be possible in different implementations, but are contemplated in this disclosure.

In some implementations, the third and fourth enclosures may be further supported by a plurality of support legs 110. In FIG. 1, a plurality of support legs 110 comprise a first end and a second end. The first end of each support leg 110 may be coupled to either the third or fourth enclosure, whereas the second end may be coupled to a wheel or caster 112. In this implementation, the second multi-enclosure assembly 142 is transportable as the casters 112 roll along a surface such as a ground or floor. One or more of the casters 112 may be configured in a locked state or unlocked state. In an unlocked state, the caster 112 may be free to roll or rotate about a rotational axis. In a locked state, the caster 112 may be held or prevented from rolling or rotating.

In one implementation, a shelf 114 may be coupled to the plurality of support legs 110. In the arrangement shown in FIG. 1, the shelf 114 may be located below the fourth enclosure 146 but above the casters 112. In some implementations, the shelf 114 may be located closer to the casters 112 to enable larger items to be stored on the shelf 114 compared to if the shelf 114 were closer to the fourth enclosure 146. The shelf 114 may be formed of wire. In one implementation, the wire may be arranged as a plurality of interconnected wires. The shelf 114 may be sized such that it is approximately the same width and depth as the third and fourth enclosures. In other implementations, the shelf 114 may be smaller than the first and second enclosures. In other implementations, the shelf 114 may comprise multiple shelves. In other implementations, another shelf 114 may be located between the third and fourth enclosures.

In the implementation of FIG. 1, the third and fourth enclosures may be arranged similar to the first enclosure and second enclosures. In other words, the third and fourth enclosures may include a top member 116, a bottom member 118, a front member 120, a back member 122, a first side member 124 and a second side member 126. The third and fourth enclosures may include a door assembly formed in one of the members, and the door assembly may include a first door 128 and a second door 130. Moreover, in some implementations, the third and fourth enclosures may include a pan 134, one or more shelves 138, and one or more ramps 140. In at least one implementation, an opening may be formed between the third and fourth enclosures to provide access therebetween. In this manner, the pan 134 in the third enclosure 144 may include a cut-out to allow an animal to travel therebetween along a ramp (not shown).

In the configuration illustrated in FIG. 1, the first multi-enclosure assembly 100 is shown offset from the second multi-enclosure assembly 142. In this configuration, a gap or space 148 may be defined between the pair of multi-enclosure assemblies. In order to connect the first multi-enclosure assembly 100 to the second multi-enclosure assembly 142, a fifth enclosure 150 may be coupled therebetween. As shown in FIG. 1, the fifth enclosure 150 may be disposed within the gap or space 148. In one implementation, the fifth enclosure 150 may be similar to each of the first enclosure 106, second enclosure 108, third enclosure 144, and fourth enclosure 146 in terms of size, shape, material, and arrangement. For example, in one implementation, the fifth enclosure 150 may include a top member 116, a bottom member 118, a front member 120, and a back member 122. In some implementations, the fifth enclosure 150 may include a first side member 124 and a second side member 126. In other implementations, the fifth enclosure 150 may not include at least one of the first side member 124 and second side member 126.

In the implementation of FIG. 1, the fifth enclosure includes at least two members missing to enable an animal, for example, to traverse between the first multi-enclosure assembly 100 and the second multi-enclosure assembly 142 via the fifth enclosure 150. In other implementations, the fifth enclosure includes a top member 116, a bottom member 118, a front member 120, a back member 122, a first side member 124 and a second side member 126, where at least two of the members include an opening through which an animal, for example, may traverse between the first multi-enclosure assembly 100 and the second multi-enclosure assembly 142 via the fifth enclosure 150.

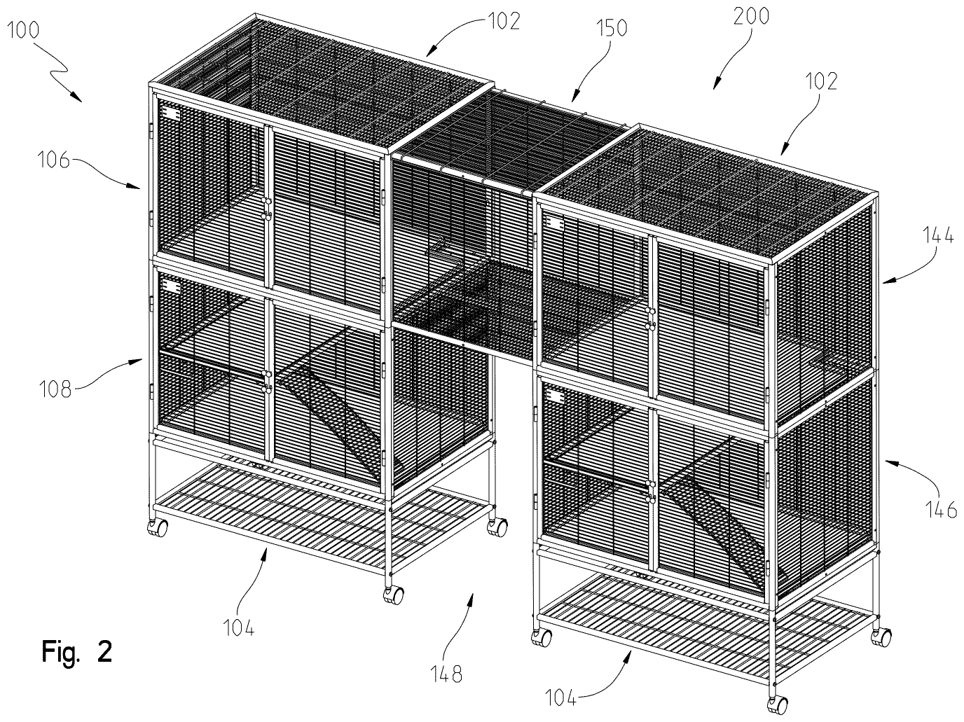

In FIG. 1, the fifth enclosure 150 is shown being coupled between the second enclosure 108 and fourth enclosure 146. As such, the fifth enclosure 150 is located towards the bottom 104 of the multi-enclosure assemblies. In other words, the fifth enclosure 150 is located generally towards the ground or surface upon which the multi-enclosure assemblies may move about. Referring to FIG. 2, another implementation is illustrated in which the fifth enclosure 150 is coupled between the first enclosure 106 and the third enclosure 144. In this configuration 200, the fifth enclosure 150 is located generally above the location of the fifth enclosure 150 in FIG. 1. Other implementations are contemplated in the present disclosure. For example, the fifth enclosure 150 may have a length that spans the entirety of the gap or space 148 and a portion of the top members of the first enclosure 106 and third enclosure 144, where an opening in each top member 116 allows an animal, for example, to traverse between the first enclosure 106 and third enclosure 144 via the fifth enclosure 150. In this example, the fifth enclosure 150 may be disposed above the first and second multi-enclosure assemblies.

In another implementation, the fifth enclosure 150 may be located between the first and third enclosures and the second and fourth enclosures such that the fifth enclosure has a length that spans the entirety of the gap 148 and at least portions of the respective top and bottom members of the different enclosures.

In yet another implementation, the fifth enclosure 150 may have a length that spans the entirety of the gap or space 148 and a portion of the bottom members 118 of the second enclosure 108 and fourth enclosure 146, where an opening in each bottom member 118 allows an animal, for example, to traverse between the second enclosure 108 and fourth enclosure 146 via the fifth enclosure 150. In this example, the fifth enclosure 150 may be disposed below the first and second multi-enclosure assemblies.

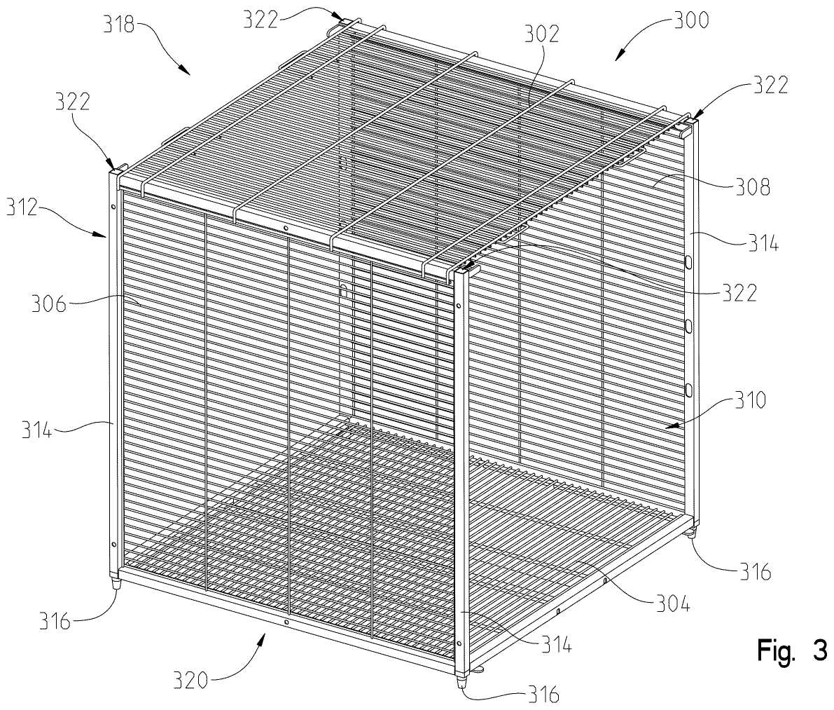

The implementations of FIGS. 1 and 2 illustrate multi-enclosure assemblies, but this is only intended to show the vast possibilities of increasing the volume or space of an enclosure via the fifth or additional enclosure 150. In some instances, it may be desirable to couple one or more enclosures to one another in a side-by-side or adjacent relationship, and to do so the additional or fifth enclosure 150 may be used for doing so. The manner in which one or more enclosures may be coupled to one another will now be described with respect to FIGS. 3-8.

Referring to FIG. 3, an enclosure assembly 300 is shown. The enclosure assembly 300 may be similar to the fifth enclosure 150 of FIGS. 1-2. In any event, the enclosure assembly 300 may include a top member 302, a bottom member 304, a front member 306, a back or rear member 308. The enclosure assembly 300 may include a first side 310 and a second side 312, where the first and second sides are located on opposite sides of the enclosure assembly 300. In addition, the enclosure assembly 300 may include a support frame 314. The support frame 314 may be formed by a plurality of tubular structures. The tubular structures may be square or rectangularly-shaped. In other implementations, the support frame 314 may be circularly or ovally-shaped. In still other implementations, the support frame 314 may be triangularly-shaped, polygonally-shaped, and the like. In some implementations, the support frame 314 may be solid or hollow.

The top member 302, the bottom member 304, the front member 306, and the back member 308 may be coupled to the support frame 314 in one or more locations. In some implementations, the different members may include interconnected wires having hook ends that couple within openings defined in the support frame 314.

A plurality of pegs 316 may be coupled to the support frame 314 to enable the enclosure assembly 300 to be coupled to other enclosure assemblies. The plurality of pegs 316 may be disposed at a bottom 320 of the enclosure assembly 300. Moreover, a plurality of openings 322 may be formed in the support frame 314 at a top 318 of the enclosure assembly 300. In this way, other enclosure assemblies may be coupled above the enclosure assembly 300 via the openings 322.

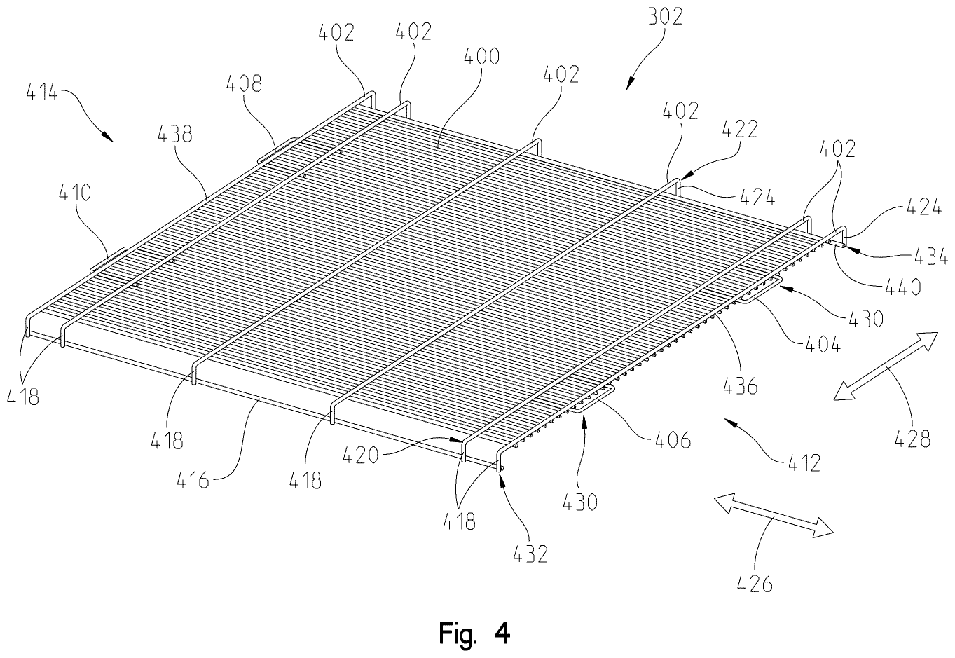

Referring to FIG. 4 of the present disclosure, one implementation of the top member 302 of the enclosure assembly 300 is shown. In this implementation, the top member 302 may include a first plurality of wires 400 and a second plurality of wires 402. The first plurality of wires 400 and the second plurality of wires 402 may be interconnected with one another. For example, as shown, the first plurality of wires 400 may extend in a first or transverse direction 426, and the second plurality of wires 402 may extend in a second or longitudinal direction 428. In at least one implementation, the first direction 426 may be perpendicular to the second direction 428. In another implementation, the first direction 426 and second direction 428 may be angularly disposed relative to one another.

The top member 302 may also include one or more U-shaped wires. For example, in FIG. 4, a first U-shaped wire 404 and a second U-shaped wire 406 may be coupled to a first side 412 of the top member 302. A third U-shaped wire 408 and a fourth U-shaped wire 410 may be coupled to a second side 414 of the top member 302. In each case, the U-shaped wires may be single wires having a first end and a second end. The first and second ends may be coupled to one or more of the second plurality of wires 402. In one implementation, each U-shaped wire may be coupled to the second plurality of wires 402 in at least four locations. In some implementations, each U-shaped wire may be coupled to at least one of the second plurality of wires 402 in at least two locations. In other implementations, each U-shaped wire may be coupled to at least two of the second plurality of wires 402 in at least two locations.

In FIG. 4, each U-shaped wire extends from an outer periphery wire of the second plurality of wires 402. In each instance, the U-shaped wire forms an extended portion 430 that extends to either the first side 412 or second side 414 a distance beyond the outer periphery wire of the second plurality of wires 402. For example, on the first side 412, the first U-shaped wire 404 and the second U-shaped wire 406 include extending portions 430 that extend past a first periphery wire 436 of the second plurality of wires 402. Further, on the second side 414, the third U-shaped wire 408 and the fourth U-shaped wire 410 include extending portions 430 that extend past a second periphery wire 438 of the second plurality of wires 402.

In one implementation, the second plurality of wires 402 may be disposed in a first plane, and the U-shaped wires may be formed in a second plane, where the second plane is parallel but offset below the first plane. In some implementations, the first plurality of wires 400 may be disposed in the same plane as the U-shaped wires.

The second plurality of wires 402 may extend generally in the second or longitudinal direction 428. Each of the second plurality of wires 402 may have a first end 432 and a second end 434. The first and second ends of the second plurality of wires 402, however, may be oriented in a downward direction. As shown in FIG. 4, each of the second plurality of wires 402 may have a first bend 420 and a second bend 424 located in at least two locations between the first and second ends thereof. The first bend 420 is located proximate the first end 432, and the second bend 424 is located proximate the second end 434.

In FIG. 4, each of the second plurality of wires includes a first bent portion 418 and a second bent portion 422. The first bent portion is located between the first end 432 and the first bend 420, while the second bent portion is located between the second end 434 and the second bend 424. The first end 432 of each of the plurality of second wires 402 is coupled to a first bottom wire 416, and the second end 434 of each of the plurality of second wires 402 is coupled to a second bottom wire 440. The first and second bottom wires include opposite ends, where each of the opposite ends is coupled to the first periphery wire 436 at the first side 412 of each bottom wire and to the second periphery wire 438 at the second side 414 thereof.

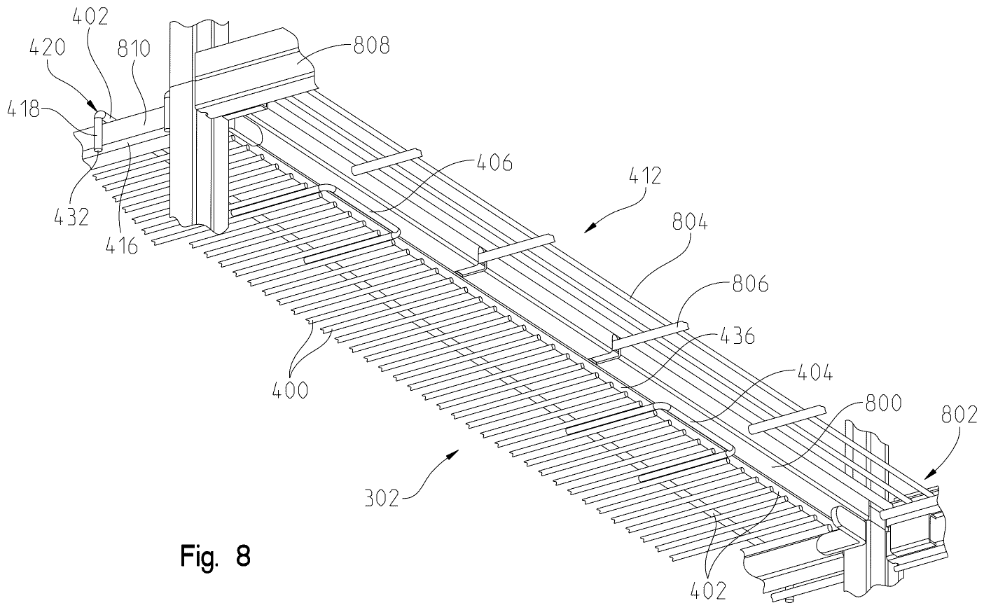

Referring to FIG. 8 in the present application, the top member 302 is shown being coupled to the enclosure assembly 300. The enclosure assembly 300 includes the support frame 314 as described above. The support frame 314 may include a third frame member 810, as shown. As shown in FIGS. 3 and 8, the first bent portion 418 of the second plurality of wires 402 of the top member 302 may contact the third frame member 810. This is partially illustrated in FIG. 8.

As also shown, the first U-shaped member 404 and second U-shaped member 406 may be positioned below a support frame of an adjacent enclosure assembly 802. The adjacent enclosure assembly 802 may include the first enclosure assembly 106, the second enclosure assembly 108, the third enclosure assembly 144, or the fourth enclosure assembly 146 in some implementations. In other implementations, the adjacent enclosure assembly 802 may be a single enclosure assembly or part of a multi-enclosure assembly. The adjacent enclosure assembly 802 may include a first plurality of wires 804 interconnected with a second plurality of wires 806.

The support frame of the adjacent enclosure assembly 802 may include a first frame member 800 and a second frame member 808. With the first U-shaped member 404 and the second U-shaped member 406 being positioned below the first frame member 800, the top member 302 may be held in position without being dislodged or decoupled from the first enclosure assembly 300. An animal, for example, contained within the enclosure assembly 300 may not be able to lift up or escape by dislodging the top member 302 due to the different U-shaped members being positioned below the support frame of the adjacent enclosure assembly 802.

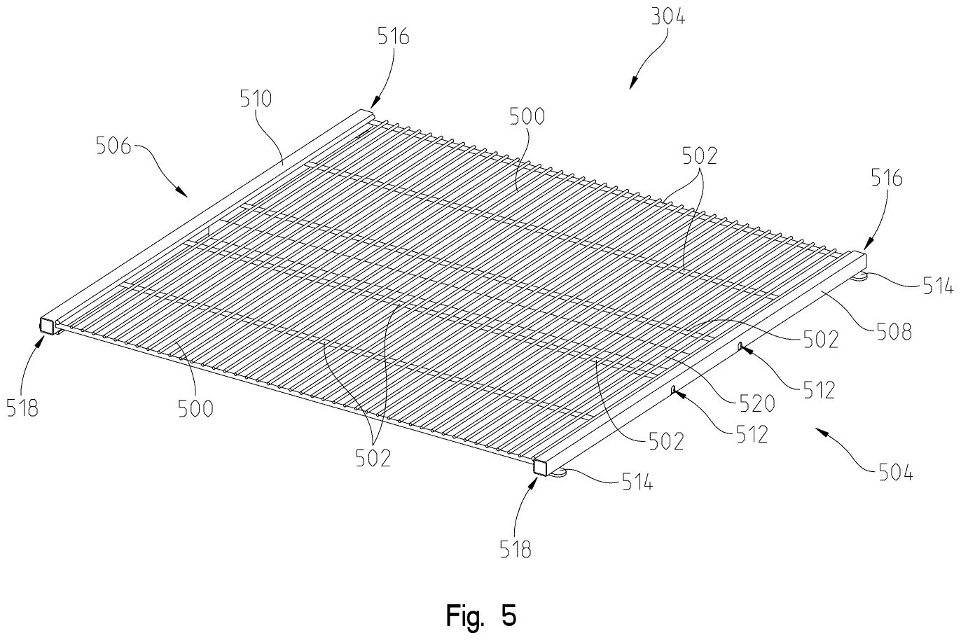

Referring to FIG. 5 of the present disclosure, a bottom member 304 of the enclosure assembly 300 of FIG. 3 is shown in greater detail. The bottom member 304 may include a first plurality of wires 500 and a second plurality of wires 502. The first and second plurality of wires may be interconnected to form a grid-like structure. The second plurality of wires 502 may extend from a first side 504 of the bottom member 304 to a second side 506 thereof. At the first side 504, the bottom member 304 may include a first frame member 508. At the second side 506, the bottom member 304 may include a second frame member 510. In one implementation, the first and second frame members may be hollow, square-shaped tubes. In other implementations, the first and second frame members may include cross-sectional tubes shaped as square, rectangular, circular, oval, or any other polygonal shape.

The first frame member 508 may include a first end 516 and a second end 518. The second frame member 510 may also include a first end 516 and a second end 518. The bottom member 304 may include a foot or tab 514 coupled at the first end 516 and the second end 518 of each frame member 508, 510. The foot or tab 514 may be positioned in contact with a support frame of another enclosure assembly, as will be described in more detail below.

The first frame member 508 and second frame member 510 may also include openings 512 formed therein. As shown in FIG. 5, the openings 512 may be located between the first end 516 and second end 518 of each frame member. In some implementations, a single opening 512 may be provided. In another implementation, a pair of openings 512 may be provided. In yet another implementation, two or more openings 512 may be formed in each frame member. The number of openings 512 may differ for each frame member in other implementations.

As also shown in FIG. 5, an intermediate frame member 520 may extend between the first side 504 and second side 506 of the bottom member 304. The intermediate frame member 520 may be structurally similar to the first frame member 508 and second frame member 510. In other implementations, the intermediate frame member 520 may be structured differently. In the illustrated implementation of FIG. 5, the intermediate frame member 520 may be positioned between two openings 512 formed in the first frame member 508 and second frame member 510.

In some implementations, the bottom member 304 may include more than one intermediate frame member 520. In one implementation, the bottom member 304 may include two or more intermediate frame members 520.

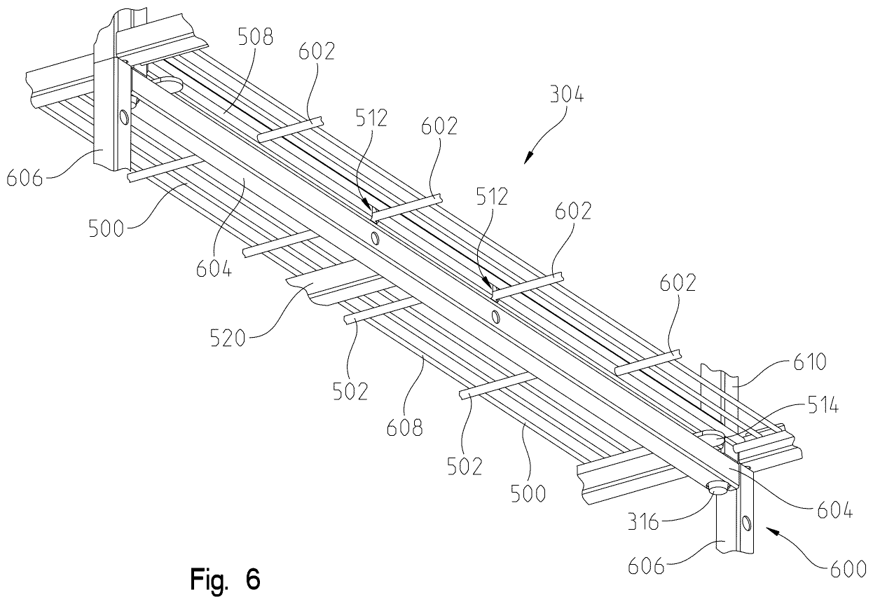

Referring to FIG. 6, the bottom member 304 is shown as part of the enclosure assembly 300 of FIG. 3. Here, a portion of the enclosure assembly 300 is shown being coupled to a second enclosure assembly 600. The second enclosure assembly 600 may include a first plurality of wires 602 and a second plurality of wires 608. The first plurality of wires 602 and second plurality of wires 608 may be interconnected with one another. The second enclosure assembly 600 may include a support frame formed by one or more frame member 604. As shown in FIG. 6, several of the first plurality of wires 602 may be disposed through the openings 512 formed in the bottom member 302. In particular, the first plurality of wires 602 may be disposed within openings 512 formed in the first frame member 508. In this way, the bottom member 304 may be coupled to the second enclosure 600. In some implementations, the openings 512 may be through-holes. In other implementations, the openings 512 may be slots or grooves. In any event, the openings 512 may be sized for receiving one or more of the first plurality of wires 602.

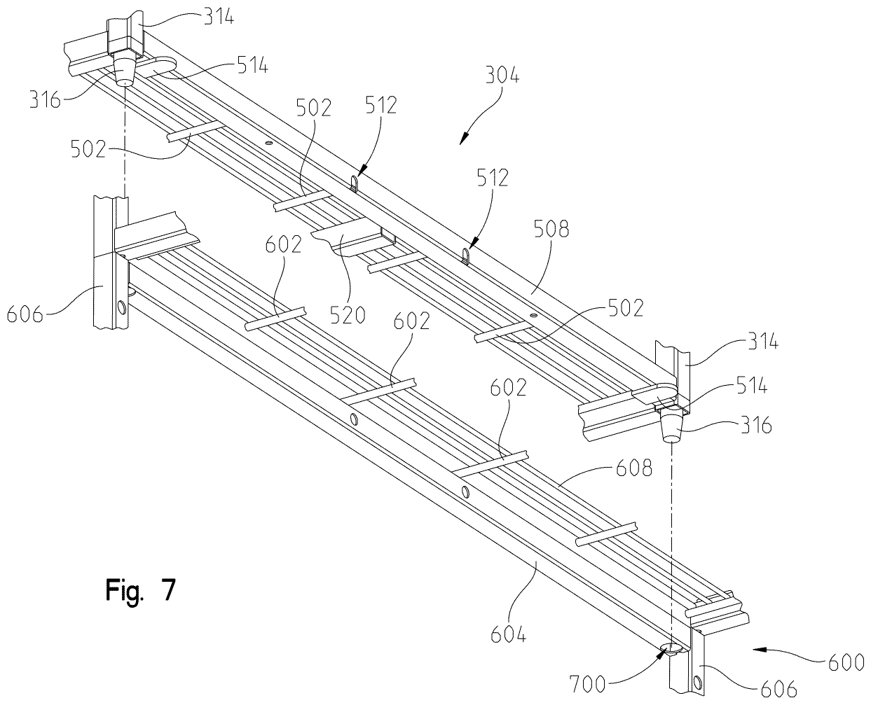

As shown in FIGS. 6 and 7, the enclosure assembly 300 includes a support frame including a post 610. A peg 316 may be downwardly disposed relative to the post 610. When assembled with the second enclosure assembly 600, the second enclosure assembly 600 may include corresponding posts 606 with openings 700 formed therein. The pegs 316 may be received within the openings 700 when coupling the enclosure assembly 300 to the second enclosure assembly 600. Thus, during assembly, the pegs 316 may be disposed within openings 700 formed in the posts of the support frame of the second enclosure assembly 600, and one or more of the first plurality of wires may disposed within openings 512 formed in the first and second frame members 508, 510 of the bottom frame 304.

In at least one implementation, a kit may include fasteners and the like for achieving the coupling between the different enclosures.

While exemplary implementations incorporating the principles of the present disclosure have been disclosed hereinabove, the present disclosure is not limited to the disclosed implementations. Instead, this application is intended to cover any variations, uses, or adaptations of the present disclosure using its general principles. Further, this application is intended to cover such departures from the present disclosure as come within known or customary practice in the art to which this disclosure pertains and which fall within the limits of the appended claims.

1. An animal enclosure configured to being coupled to a second animal enclosure, comprising:
a plurality of members defining an interior of the enclosure, the plurality of members comprising at least a first member, a second member, a third member, and a fourth member, where the first member, second member, third member, and fourth member are at least partially formed by a plurality of interconnected horizontal and vertical wires; and
a support frame coupled to at least two member of the plurality of members;
wherein, the first member comprises a first plurality of wires and a second plurality of wires, the first plurality of wires extending in a first direction and the second plurality of wires extending in a second direction;
wherein, the first member comprises at least on U-shaped wire coupled to at least one of the second plurality of wires;
wherein, the second member comprises a first frame member, a second frame member, a third plurality of wires and a fourth plurality of wires, where the third plurality of wires are disposed generally parallel to the first and second frame members, and at least one of the fourth plurality of wires are coupled to the first and second frame members.

2. The animal enclosure of claim 1, wherein the first and second frame members are formed of rectangular or square cross-sectional tubular members.

3. The animal enclosure of claim 1, wherein the first member forms a top member of the animal enclosure and the second member forms a bottom member thereof.

4. The animal enclosure of claim 1, wherein the second member comprises a first tab coupled to the first frame member and a second tab coupled to the second frame member, the first tab extending outwardly from the first frame member in one direction and the second tab extending outwardly from the second frame member in another direction.

5. The animal enclosure of claim 4, wherein the first tab and second tab extend in a direction parallel to the fourth plurality of wires.

6. The animal enclosure of claim 1, wherein the first frame member includes a first end and a second end;
wherein, the first frame member forms a first opening and a second opening at locations between the first end and the second end, the first opening spaced from the second opening.

7. The animal enclosure of claim 6, wherein the second frame member includes a first end and a second end;
wherein, the second frame member forms a third opening and a fourth opening at locations between the first end and the second end of the second frame member, the third opening spaced from the fourth opening.

8. The animal enclosure of claim 7, wherein the first opening is axially aligned with the third opening, and the second opening is axially aligned with the fourth opening.

9. The animal enclosure of claim 1, wherein the second member comprises an intermediate member coupled to the first frame member and the second frame member, the intermediate member located at one end between the first and second openings and at an opposite end thereof between the third and fourth openings.

10. The animal enclosure of claim 1, wherein the support frame comprises a top end and a bottom end, the support frame forming a peg at the bottom end and an opening at the top end.

11. The animal enclosure of claim 1, wherein the first member forms a top, the second member forms a bottom, the third member forms a front, and the fourth member forms a rear, the first member, second member, third member, and fourth member coupled to one another to define the interior of the enclosure.

12. The animal enclosure of claim 11, wherein the interior of the enclosure is open at a first side and a second side thereof, the first member, second member, third member, and fourth member defining the first side and the second side.

13. The animal enclosure of claim 1, wherein the second plurality of wires of the first member form an elongate portion, a first bent portion and a second bent portion.

14. The animal enclosure of claim 13, wherein the first bent portion is coupled to a first bottom wire and the second bent portion is coupled to a second bottom wire.

15. The animal enclosure of claim 14, wherein the elongate portion of each of the second plurality of wires is disposed within a first plane and the first and second bottom wires are disposed within a second plane, the first plane being parallel to and offset from the second plane.

16. The animal enclosure of claim 1, wherein the at least one U-shaped wire is coupled in at least two locations along the U-shaped wire to a first wire of the second plurality of wires and to a second wire of the second plurality of wires.

17. An animal enclosure assembly configured to contain an animal, comprising:
a first enclosure defining a first interior and a second enclosure defining a second interior, the first enclosure and second enclosure being coupled to one another such that the first interior is directly connected to the second interior;
the first enclosure comprising a first plurality of members defining the first interior and the second enclosure comprising a second plurality of members defining the second interior;
the first enclosure further comprising:
the plurality of members comprising at least a first member, a second member, a third member, and a fourth member, where the first member, second member, third member, and fourth member are at least partially formed by a plurality of interconnected horizontal and vertical wires; and
a support frame coupled to at least two member of the plurality of members;
wherein, the first member comprises a first plurality of wires and a second plurality of wires, the first plurality of wires extending in a first direction and the second plurality of wires extending in a second direction;
wherein, the first member comprises at least on U-shaped wire coupled to at least one of the second plurality of wires;
wherein, the second member comprises a first frame member, a second frame member, a third plurality of wires and a fourth plurality of wires, where the third plurality of wires are disposed generally parallel to the first and second frame members, and at least one of the fourth plurality of wires are coupled to the first and second frame members.

18. The animal enclosure assembly of claim 17, wherein the first frame member includes a first end and a second end;
wherein, the first frame member forms a first opening and a second opening at locations between the first end and the second end, the first opening spaced from the second opening;
wherein, when the first enclosure and second enclosure are coupled to one another, a first wire of the second enclosure is located within the first opening and a second wire of the second enclosure is located within the second opening.

19. The animal enclosure assembly of claim 18, wherein the second frame member includes a first end and a second end;
wherein, the second frame member forms a third opening and a fourth opening at locations between the first end and the second end of the second frame member, the third opening spaced from the fourth opening;
wherein the first wire of the second enclosure is located within the third opening and the second wire of the second enclosure is located within the fourth opening.

20. The animal enclosure assembly of claim 17, wherein the first member forms a top member of the first enclosure and the second member forms a bottom member thereof.
